(19) United States
(12) Patent Application Publication
(10) Pub. No.: US 2011/0129160 A1
(43) Pub. Date: Jun. 2, 2011

(54) IMAGE PROCESSING APPARATUS AND IMAGE PROCESSING METHOD IN THE IMAGE PROCESSING APPARATUS

(76) Inventor: Eiki Obara, Hiki-gun (JP)

(21) Appl. No.: 12/891,423

(22) Filed: Sep. 27, 2010

(30) Foreign Application Priority Data
Nov. 27, 2009 (JP) 2009-270597

(51) Int. Cl. G06K 9/40; G06K 9/36

(52) U.S. Cl. 382/233; 382/268

(57) ABSTRACT

According to one embodiment, an image processing apparatus includes a block boundary detection module which detects a block boundary in input image data. The block boundary detection module includes a first calculator, a second calculator, and a determination module. The first calculator calculates a first value which is an absolute value of an adjacent pixel value difference between two adjacent pixels in the image data. The second calculator calculates a second value which is a value obtained by multiplying, by a predetermined coefficient, a sum value of absolute values of adjacent pixel value differences between pixels positioned in a direction in which the two adjacent pixels are aligned, the two adjacent pixels being excluded from calculation of the second value. The determination module determines that a block boundary exists between the two pixels when the first value is larger than the second value.

### CROSS-REFERENCE TO RELATED APPLICATIONS

This application is based upon and claims the benefit of priority from Japanese Patent Application No. 2009-270597, filed Nov. 27, 2009; the entire contents of which are incorporated herein by reference.

### FIELD

Embodiments described herein relate generally to a block distortion removal technique suitable for an image processing apparatus which decompresses and decodes image data subjected to compression encoding compliant with, e.g., the H.264 standard.

### BACKGROUND

For example, in a Moving Picture Experts Group (MPEG) 2 image compression method, because the processing unit is a block of 8×8 pixels, a boundary (block boundary) called a block distortion or the like appears in each block of 8×8 pixels. To make the block distortion less conspicuous, filtering processing (for a fixed position) is executed for the block boundary.

To the contrary, in the latest image compression methods such as H.264, the block size serving as a processing unit is not a fixed size of 8×8 pixels. In many cases, filtering processing for a fixed position is not effective.

Recently, it is popular to download, via the Internet, so called Internet contents such as video data posted to a video sharing website, and view them. Internet contents of this type include one obtained by temporarily decompressing a compressed image, changing the image size, and then compressing the image again, and one obtained by decompressing a recompressed image, changing the size, and then displaying the image. In many of these Internet contents, the block boundary does not appear in each unit of 8×8 pixels. Also in this case, filtering processing for a fixed position cannot remove a block distortion and the block distortion often remains.

To solve this problem, there have been proposed a video signal processing apparatus and the like capable of “detecting a plurality of block widths using a simple arrangement for a signal which has been encoded and decoded for each block, and the position and width of the block boundary of which are unknown” (for example, Jpn. Pat. Appln. KOKAI Publication No. 2008-124901).

The video signal processing apparatus in Jpn. Pat. Appln. KOKAI Publication No. 2008-124901, however, determines a block boundary based on the data difference value between adjacent pixels. The apparatus may therefore mistake a so called edge of a pattern or the like for a block boundary.

Further, the foregoing filtering processing has a disadvantage that the detail component (contrast component of a local region) of an original image is lost when filtering processing is executed for a block boundary to make a block distortion less conspicuous.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary block diagram showing a schematic arrangement of an image processing apparatus according to an embodiment.

FIG. 2 is an exemplary block diagram showing detailed functional blocks of the image processing apparatus according to the embodiment.

FIG. 3 is an exemplary view showing an image of pixels aligned in the horizontal direction.

FIG. 4 is an exemplary flowchart showing the operation sequence of the image processing apparatus according to the embodiment.

FIG. 5 is an exemplary flowchart showing the sequence of block boundary detection processing executed by the image processing apparatus according to the embodiment.

### DETAILED DESCRIPTION

Various embodiments will be described hereinafter with reference to the accompanying drawings.

In general, according to one embodiment, an image processing apparatus includes a block boundary detection module which detects a block boundary in input image data. The block boundary detection module includes a first calculator, a second calculator, and a determination module. The first calculator calculates a first value which is an absolute value of an adjacent pixel value difference between two adjacent pixels in the image data. The second calculator calculates a second value which is a value obtained by multiplying, by a predetermined coefficient, a sum value of absolute values of adjacent pixel value differences between pixels positioned in a direction in which the two adjacent pixels are aligned, the two adjacent pixels being excluded from calculation of the second value. The determination module determines that a block boundary exists between the two pixels when the first value is larger than the second value.

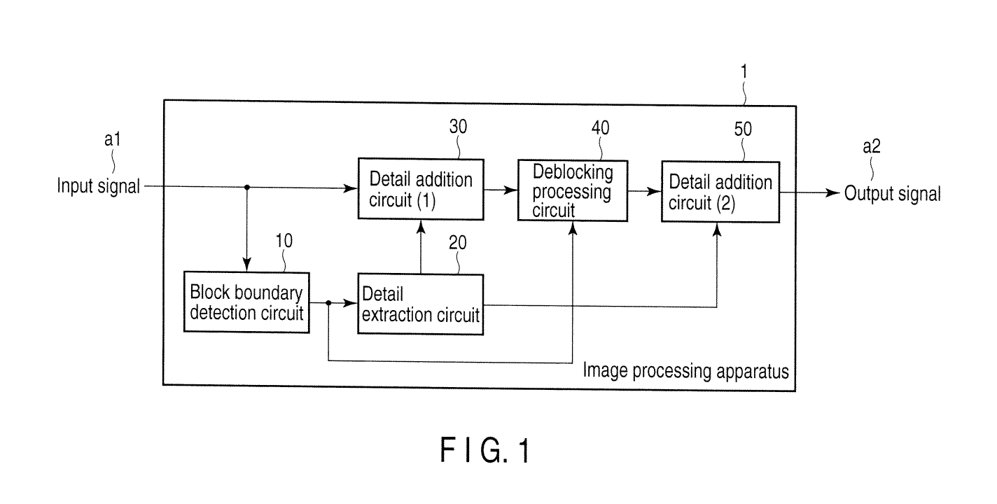

FIG. 1 is an exemplary block diagram showing the schematic arrangement of an image processing apparatus 1 according to the embodiment.

Assume that an input signal “a1” is a signal in which the size of a block processed in image compression is unknown and which contains block noise. The input signal “a1” is input to a block boundary detection circuit 10 and a detail addition circuit (1) 30. The block boundary detection circuit 10 detects a block boundary in the input signal “a1”. The block boundary detection method will be described later.

The block boundary detection circuit 10 sends the detected block boundary information to a detail extraction circuit 20 and a deblocking processing circuit 40. The detail extraction circuit 20 extracts the contrast component (to be also referred to as a detail component) of a local region so as not to cross a block boundary. As for pixels which sandwich the block boundary, the detail extraction circuit 20 performs smoothing processing. The detail component extraction method will also be described later.

The detail addition circuit (1) 30 adds a detail component to the input signal “a1” to compensate in advance for a detail component which may be lost in the subsequent deblocking processing circuit 40. An output from the detail addition circuit (1) 30 is input to the deblocking processing circuit 40. The deblocking processing circuit 40 executes deblocking processing based on the block boundary information sent from the block boundary detection circuit 10. In the deblocking processing, a boundary step is made inconspicuous using, for example, a low-pass filter. The deblocking processing circuit 40 dynamically switches the tap size of the filter and the number of pixels to be processed in accordance with the size of a step contained in block boundary information. A detail addition circuit (2) 50 adds a detail component again to the signal in which the block boundary has been made inconspicuous by the deblocking processing circuit 40, obtaining an output signal “a2”.

Note that FIG. 1 shows two detail addition circuits, i.e., the detail addition circuit (1) 30 which compensates in advance for a detail component that may be lost in the deblocking processing circuit 40, and the detail addition circuit (2) 50 which compensates for a detail component which has been lost in the deblocking processing circuit 40. However, it suffices to arrange either of the detail addition circuits.

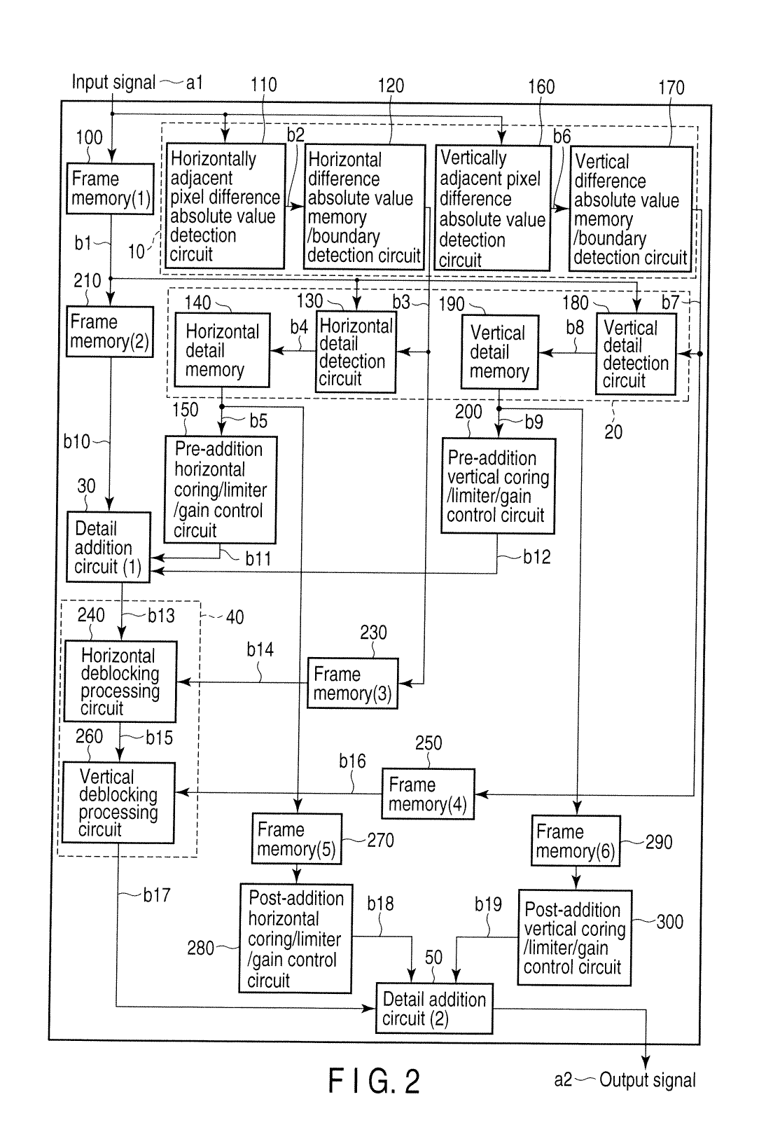

FIG. 2 is an exemplary block diagram showing detailed functional blocks of the image processing apparatus 1 according to the embodiment.

As described above, the input signal “a1” is a signal in which the size of a block processed in image compression is unknown and which contains block noise. The input signal “a1” is input to a frame memory (1) 100, a horizontally adjacent pixel difference absolute value detection circuit 110, and a vertically adjacent pixel difference absolute value detection circuit 160. An output signal “b1” from the frame memory (1) 100 is input to a frame memory (2) 210, a horizontal detail detection circuit 130, and a vertical detail detection circuit 180.

The horizontally adjacent pixel difference absolute value detection circuit 110 processes all the horizontal pixels of an image in one frame, and outputs obtained information “b2” to a horizontal difference absolute value memory/boundary detection circuit 120. Data “b3” read from the horizontal difference absolute value memory/boundary detection circuit 120 is input to the horizontal detail detection circuit 130 and a frame memory (3) 230.

The horizontal detail detection circuit 130 receives the data “b3” output from the horizontal difference absolute value memory/boundary detection circuit 120, and the output signal “b1” from the frame memory (1) 100. The horizontal detail detection circuit 130 determines a block boundary based on information of the data “b3”, and extracts a detail component so as not to cross the block boundary. As for pixels which sandwich the block boundary, the horizontal detail detection circuit 130 performs smoothing processing for the pixels which sandwich the boundary after extracting detail components near the block boundary, and writes a horizontal detail component as final horizontal detail component data “b4” in a horizontal detail memory 140. An output signal “b5” from the horizontal detail memory 140 is input to a pre-addition horizontal coring/limiter/gain control circuit 150 and a frame memory (5) 270.

The pre-addition horizontal coring/limiter/gain control circuit 150 adjusts the addition level of the horizontal detail component. If the level is low, noise is generated, so the pre-addition horizontal coring/limiter/gain control circuit 150 stops addition by coring processing. If the level is excessively high, the pre-addition horizontal coring/limiter/gain control circuit 150 limits the addition amount by limiter processing.

The vertically adjacent pixel difference absolute value detection circuit 160 processes all the vertical pixels of an image in one frame, and outputs obtained information “b6” to a vertical difference absolute value memory/boundary detection circuit 170. Data “b7” read from the vertical difference absolute value memory/boundary detection circuit 170 is input to a vertical detail detection circuit 180 and a frame memory (4) 250.

The vertical detail detection circuit 180 receives the data “b7” output from the vertical difference absolute value memory/boundary detection circuit 170, and the output signal “b1” from the frame memory (1) 100. The vertical detail detection circuit 180 determines a block boundary based on information of the data “b7”, and extracts a detail component so as not to cross the block boundary. As for pixels which sandwich the block boundary, the vertical detail detection circuit 180 performs smoothing processing for the pixels which sandwich the boundary after extracting detail components near the block boundary, and writes a vertical detail component as final vertical detail component data “b8” in a vertical detail memory 190. An output signal “b9” from the vertical detail memory 190 is input to a pre-addition vertical coring/limiter/gain control circuit 200 and a frame memory (6) 290.

The pre-addition vertical coring/limiter/gain control circuit 200 adjusts the addition level of the vertical detail component. If the level is low, noise is generated, so the pre-addition vertical coring/limiter/gain control circuit 200 stops addition by coring processing. If the level is excessively high, the pre-addition vertical coring/limiter/gain control circuit 200 limits the addition amount by limiter processing.

An input signal “b10” whose delay time has been adjusted by the frame memory (2) 210 is input to the detail addition circuit (1) 30. The detail addition circuit (1) 30 adds, to the delayed input signal “b10”, an output signal “b11” from the pre-addition horizontal coring/limiter/gain control circuit 150 and an output signal “b12” from the pre-addition vertical coring/limiter/gain control circuit 200. In this way, the detail addition circuit (1) 30 compensates in advance for a detail component which may be lost in subsequent deblocking processing. A signal “b13” whose detail component has been compensated for by the detail addition circuit (1) 30 is input to a horizontal deblocking processing circuit 240.

In addition to the signal “b13” whose detail component has been compensated, the horizontal deblocking processing circuit 240 receives information “b14” about a horizontal block boundary that has been output from the horizontal difference absolute value memory/boundary detection circuit 120 and delayed by the frame memory (3) 230. The information “b14” contains positional information of the horizontal boundary, and step value information of the horizontal block boundary. Based on these pieces of information, the horizontal deblocking processing circuit 240 sets a position to undergo filtering processing, and selects a filter corresponding to the step value. A signal “b15” obtained by correcting a horizontal block boundary step by the horizontal deblocking processing circuit 240 is input to a vertical deblocking processing circuit 260.

In addition to the signal “b15” subjected to horizontal deblocking processing, the vertical deblocking processing circuit 260 receives information “b16” about a vertical block boundary that has been output from the vertical difference absolute value memory/boundary detection circuit 170 and delayed by the frame memory (4) 250. The information “b16” contains positional information of the vertical boundary, and step value information of the vertical block boundary. Based on these pieces of information, the vertical deblocking processing circuit 260 sets a position to undergo filtering processing, and selects a filter corresponding to the step value. A signal “b17” obtained by correcting a vertical block boundary step by the vertical deblocking processing circuit 260 is input to the detail addition circuit (2) 50.

The detail addition circuit (2) 50 adds a detail signal “b18” obtained by optimizing the level by a post-addition horizontal coring/limiter/gain control circuit 280 after the frame memory (5) 270 delays a detail component read from the horizontal detail memory 140, and a detail signal “b19” obtained by optimizing the level by a post-addition vertical coring/limiter/gain control circuit 300 after the frame memory (6) 290 delays a detail component read from the vertical detail memory 190. In this manner, the detail addition circuit (2) 50 compensates for a detail component which has been lost in deblocking processing. Note that the functions of the post-addition horizontal coring/limiter/gain control circuit 280 and the post-addition vertical coring/limiter/gain control circuit 300 are the same as those of the pre-addition horizontal coring/limiter/gain control circuit 150 and the pre-addition vertical coring/limiter/gain control circuit 200, and a description thereof will not be repeated.

By this processing, the output signal “a2” from the detail addition circuit (2) 50 becomes signal in which the block boundary step is suppressed and the detail component is compensated for.

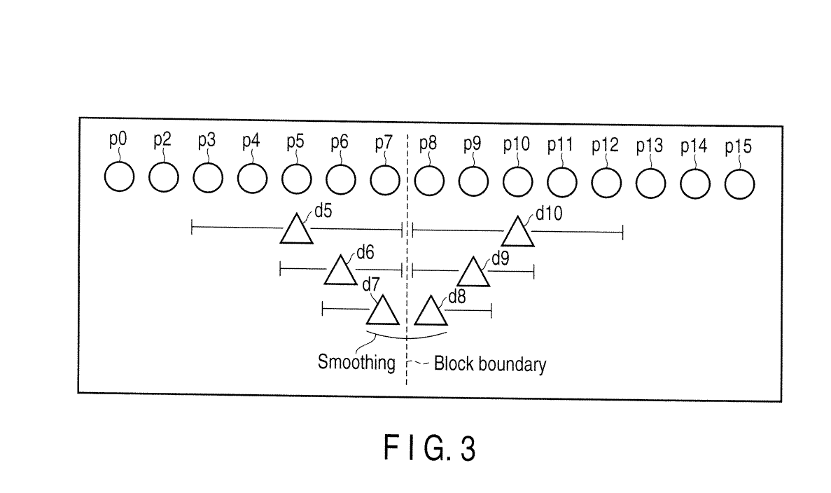

Block boundary detection processing executed by the image processing apparatus 1 in the embodiment will be explained with reference to FIG. 3. FIG. 3 is an exemplary view showing an image of pixels aligned in the horizontal direction.

In FIG. 3, a circle represents a pixel, pn represents the number of each pixel, and do represents the detail component of each pixel. In the following description, a pixel number with a suffix “m” represents the pixel value of a pixel.

Assume that the horizontally adjacent pixel difference absolute value detection circuit 110 shown in FIG. 2 has already detected the absolute values of horizontally adjacent pixels. For example, letting dif be the difference absolute value between pixels p7 and p8 shown in FIG. 3,

dif=|p7m−p8m| equation (1).

Letting sad be the sum of the difference absolute values between adjacent pixels p4 to p11 except for the difference absolute value between pixels p7 and p8,

sad=|p4m−p5m|+|p5m−p6m|+|p6m−p7m|+|p8m−p9m|+|p9m−p10m|+|p10m−p11m| equation (2).

When dif and sad have a relationship:

dif>sad×k equation (3),

the image processing apparatus 1 in the embodiment determines that a block boundary exists between pixels p7 and p8. In equation (3), k is a coefficient. The k value varies depending on the contents, compression ratio, image enlargement/reduction ratio, and the like. By appropriately setting the k value in accordance with the contents, compression ratio, image enlargement/reduction ratio, and the like, a block boundary can be detected at very high probability. The block boundary of an entire frame can be detected by performing this processing for all horizontal and vertical pixels.

A filter arrangement corresponding to the step value of a detected block boundary will be exemplified. The step value will be explained with reference to dif and FIG. 3 used in the above description.

Assume that a block boundary exists between pixels p7 and p8 shown in FIG. 3. Then, a corrected pixel value new_pxm can be calculated as follows.

(1) For dif<4: Smoothing Processing for Two Pixels Which Sandwich Boundary

new_{—}p7m=(p7m+p8m)/2 equation (4)

new_{—}p8m=(p7m+p8m)/2 equation (5)

(2) For 4<=dif<8: 4 pixel Processing Using 3 tap Filter

new_{—}p6m=(p5m+p6m×2+p7m)/4 equation (6)

new_{—}p7m=(p6m+p7m×2+p8m)/4 equation (7)

new_{—}p8m=(p7m+p8m×2+p9m)/4 equation (8)

new_{—}p9m=(p8m+p9m×2+p10m)/4 equation (9)

(3) For 8<=dif<20: 6 pixel Processing Using 5 tap Filter

new_{—}p5m=(p3m+p4m×2+p5m×4+p6m×2+p7m)/10 equation (10)

new_{—}p6m=(p4m+p5m×2+p6m×4+p7m×2+p8m)/10 equation (11)

new_{—}p7m=(p5m+p6m×2+p7m×4+p8m×2+p9m)/10 equation (12)

new_{—}p8m=(p6m+p7m×2+p8m×4+p9m×2+p10m)/10 equation (13)

new_{—}p9m=(p7m+p8m×2+p9m×4+p10m×2+p11m)/10 equation (14)

new_{—}p10m=(p8m+p9m×2+p10m×4+p11m×2+p12m)/10 equation (15)

(4) For 20<=dif

No deblocking processing is done.

Note that these dif value range settings are merely examples.

That is, the deblocking processing circuit 40 includes a function of selecting and applying an appropriate filter in accordance with the step value of a block boundary.

Next, the operation principles of the horizontal detail detection circuit 130 and the vertical detail detection circuit 180 shown in FIG. 2 will be explained. The horizontal detail detection circuit 130 and the vertical detail detection circuit 180 include the same function except for the difference between the horizontal and vertical directions. Thus, only an operation in the horizontal direction will be described. A method of obtaining a detail (local region contrast) component will be exemplified.

In the description of FIG. 2, the block boundary detection circuit 10 detects the block boundary of an entire image before detecting a detail component. Extraction of the detail components d5 to d10 of pixels p5 to p10 will be exemplified, assuming that a block boundary exists between pixels p7 and p8 shown in FIG. 3. The important point to note is that extracting detail components which sandwich the block boundary is not performed, and smoothing processing is performed for the detail components of pixels which sandwich a boundary.

d5=p5m−(p3m+p4m+p5m+p6m+p7m)/5 equation (16)

d6=p6m−(p5m+p6m+p7m)/3 equation (17)

d7=p7m−(p6m+p7m)/2 equation (18)

d8=p8m−(p8m+p9m)/2 equation (19)

d9=p9m−(p8m+p9m+p10m)/3 equation (20)

d10=p10m−(p8m+p9m+p10m+p11m+p12m)/5 equation (21)

In this case, d7 and d8 are detail components which sandwich the block boundary, and undergo smoothing processing. A detail component border_dx after smoothing processing is calculated by

border_{—}d7=(d7+d8)/2 equation (22)

border_{—}d8=(d7+d8)/2 equation (23)

The image processing apparatus 1 in the embodiment that executes the above described block boundary detection processing, detail detection processing, and detail addition processing can reduce a block distortion even when the block size used for image compression is not definite. Even a detail component which is lost by filtering in deblocking processing can be reconstructed, greatly improving the image quality.

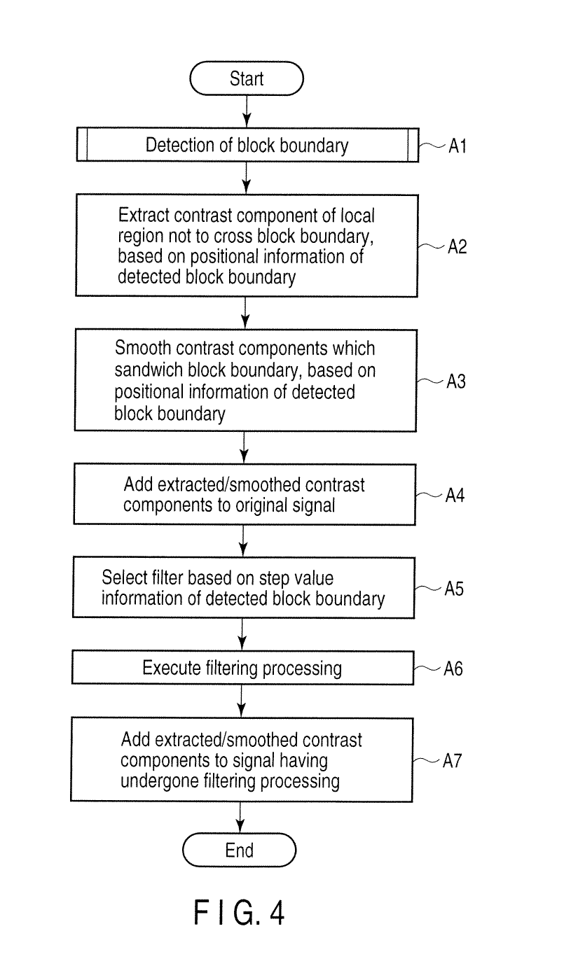

FIG. 4 is an exemplary flowchart showing the operation sequence of the image processing apparatus 1 in the embodiment.

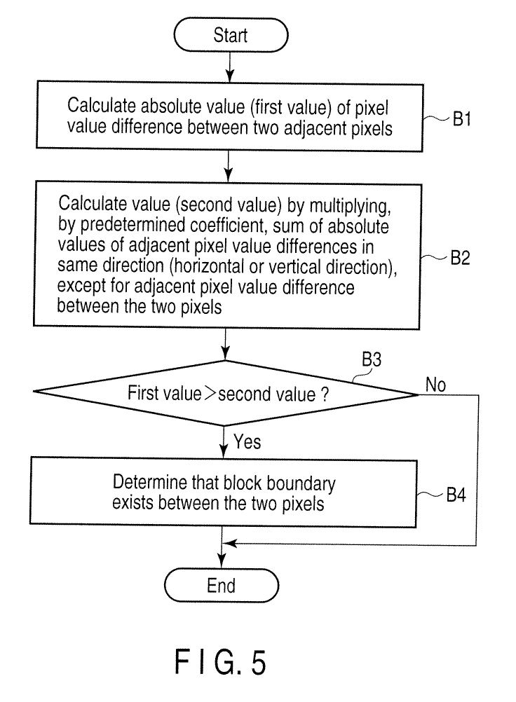

Upon receiving a signal in which the size of a block processed in image compression is unknown and which contains block noise, the image processing apparatus 1 in the embodiment first detects a block boundary (block A1). FIG. 5 is an exemplary flowchart showing the sequence of block boundary detection processing.

The image processing apparatus 1 calculates the absolute value of a pixel value difference between two adjacent pixels (block B1). The image processing apparatus 1 calculates a value by multiplying, by a predetermined coefficient, the sum of the absolute values of adjacent pixel value differences in the same direction as that in which these two pixels are aligned (block B2).

The image processing apparatus 1 compares the value calculated in block B1 with that calculated in block B2 (block B3). If the value calculated in block B1 is larger than that calculated in block B2 (YES in block B3), the image processing apparatus 1 determines that a block boundary exists between these two pixels (block B4).

Then, based on positional information of the detected block boundary, the image processing apparatus 1 extracts the contrast component of a local region so as not to cross the block boundary (block A2). Also, based on positional information of the detected block boundary, the image processing apparatus 1 smoothes contrast components which sandwich the block boundary (out of contrast components extracted in block A2) (block A3). The image processing apparatus 1 adds the extracted/smoothed contrast components to an original signal (before filtering processing in order to make a block distortion less conspicuous) (block A4).

Based on step value information of the detected block boundary, the image processing apparatus 1 selects a filter to be applied to filtering processing (block A5), and executes filtering processing (block A6). The image processing apparatus 1 adds the contrast components extracted and smoothed in blocks A2 and A3 to the signal subjected to filtering processing (block A7).

Note that FIG. 4 shows two blocks, i.e., the block (block A4) of adding extracted/smoothed contrast components to an original signal (before filtering processing), and the block (block A7) of adding extracted/smoothed contrast components to a signal subjected to filtering processing. However, it suffices to execute either of the blocks.

As described above, the image processing apparatus 1 according to the embodiment can accurately detect a block boundary and perform effective image processing for the block boundary.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
an input module configured to input image data obtained by decompressing and decoding image data which has been compressed and encoded for each block;
a block boundary detection module configured to detect a block boundary in the image data input by the input module;
a deblocking module configured to execute filtering processing for the input image data to remove a block distortion, based on the block boundary detected by the block boundary detection module; and
an output module configured to output the image data for which the filtering processing is executed by the deblocking module,
wherein the block boundary detection module comprises:
a first calculator configured to calculate an absolute value of an adjacent pixel value difference between two adjacent pixels in the image data;
a second calculator configured to calculate a value by multiplying, by a predetermined coefficient, a sum value of absolute values of adjacent pixel value differences between pixels positioned in a direction in which the two adjacent pixels used by the first calculator are aligned, the two adjacent pixels used by the first calculator being excluded from calculation by the second calculator; and
a determination module configured to determine that a block boundary exists between the two pixels when the value calculated by the first calculator is larger than the value calculated by the second calculator.

2. The apparatus of claim 1, further comprising:
a detail extraction module configured to extract a contrast component of a local region using pixel value information obtained from pixel values of neighboring pixels between which the block boundary detected by the block boundary detection module does not exist; and
a detail addition module configured to add the contrast component of the local region extracted by the detail extraction module to either of image data input to the deblocking module and image data output from the deblocking module.

3. The apparatus of claim 2, wherein the detail extraction module comprises a smoothing module configured to smooth respective contrast components of two local regions extracted for two pixels adjacent across the block boundary detected by the block boundary detection unit, by using the contrast components of the two local regions.

4. The apparatus of claim 2, wherein the pixel value information obtained from the pixel values of the neighboring pixels comprises difference information between an output value of a smoothing filter and a pixel value.

5. The apparatus of claim 1, wherein the deblocking module comprises a filter selection module configured to select one of filters having different characteristics in accordance with an absolute value of a pixel value difference between two pixels adjacent across the block boundary, and to apply the selected filter to filtering processing for the block boundary.

6. An image processing apparatus comprising:
an input module configured to input image data obtained by decompressing and decoding image data which has been compressed and encoded for each predetermined block;
a detail extraction module configured to extract a contrast component of a local region using pixel value information obtained from pixel values of neighboring pixels so as not to cross a block boundary in the image data input by the input module;
a deblocking module configured to execute filtering processing to remove a block distortion on the block boundary in the image data input by the input module;
an output module configured to output image data for which the filtering processing is executed by the deblocking module; and
a detail addition module configured to add the contrast component of the local region extracted by the detail extraction module to either of image data input to the deblocking module and image data output from the deblocking module.

7. The apparatus of claim 6, wherein the detail extraction module comprises a smoothing module configured to smooth respective contrast components of two local regions extracted for two pixels adjacent across the block boundary, by using the contrast components of the two local regions.

8. The apparatus of claim 6, wherein the pixel value information obtained from the pixel values of the neighboring pixels comprises difference information between an output value of a smoothing filter and a pixel value.

9. The apparatus of claim 6, wherein the deblocking module comprises a filter selection module configured to select one of filters having different characteristics in accordance with an absolute value of a pixel value difference between two pixels adjacent across the block boundary in filtering processing for the block boundary in the image data input by the input module.

10. An image processing method of an image processing apparatus, comprising:
inputting image data obtained by decompressing and decoding image data which has been compressed and encoded for each block;
detecting a block boundary in the input image data;
executing filtering processing for the input image data to remove a block distortion, based on the detected block boundary; and
outputting the image data subjected to the filtering processing,
wherein the detecting a block boundary comprises:
calculating a first value which is an absolute value of an adjacent pixel value difference between two adjacent pixels in the image data;
calculating a second value which is a value obtained by multiplying, by a predetermined coefficient, a sum value of absolute values of adjacent pixel value differences between pixels positioned in a direction in which the two adjacent pixels used by calculation of the first value are aligned, the two adjacent pixels used by calculation of the first value being excluded from calculation of the second value; and
determining that a block boundary exists between the two pixels when the first value is larger than the second value.

11. The method of claim 10, further comprising:
extracting a contrast component of a local region using pixel value information obtained from pixel values of neighboring pixels between which the detected block boundary does not exist; and
adding the extracted contrast component of the local region to either of image data before the executing filtering processing to remove a block distortion and image data after the executing filtering processing to remove a block distortion.

12. The method of claim 10, wherein the extracting a contrast component of a local region comprises smoothing respective contrast components of two local regions extracted for two pixels adjacent across the detected block boundary, by using the contrast components of the two local regions.

13. The method of claim 10, wherein the pixel value information obtained from the pixel values of the neighboring pixels comprises difference information between an output value of a smoothing filter and a pixel value.

14. The method of claim 10, wherein the executing filtering processing to remove a block distortion comprises selecting one of filters having different characteristics in accordance with an absolute value of a pixel value difference between two pixels adjacent across the block boundary, and applying the selected filter to filtering processing for the block boundary.
